(19) United States
(12) Patent Application Publication
(10) Pub. No.: US 2019/0271988 A1
(43) Pub. Date: Sep. 5, 2019

(54) SYSTEMS AND METHODS FOR DELIVERING MERCHANDISE USING AUTONOMOUS GROUND VEHICLES

(71) Applicant: Walmart Apollo, LLC, Bentonville, AR (US)

(72) Inventors: Donald R. High, Noel, MO (US); Robert L. Cantrell, Herndon, VA (US); Michael D. Atchley, Eureka Springs, AR (US); Brian G. McHale, Chadderton Oldham (GB); John J. O'Brien, Farmington, AR (US); Nathan G. Jones, Bentonville, AR (US)

(21) Appl. No.: 16/283,282

(22) Filed: Feb. 22, 2019

Related U.S. Application Data
(60) Provisional application No. 62/637,568, filed on Mar. 2, 2018.

(51) Int. Cl. G05D 1/02

(52) U.S. Cl. CPC G05D 1/0276; G01C 21/3407; G05D 1/0214

(57) ABSTRACT

In some embodiments, systems and methods are provided herein useful for delivering merchandise using autonomous ground vehicles (AGVs) linking to and unlinking from other AGVs. In some embodiments, the system includes a plurality of AGVs where each AGV has a storage area and couplers at each end of the AGV and a first linked orientation in which the AGVs are linked end to end in a predetermined sequence. The system further includes centralized control circuit configured to receive a plurality of merchandise orders for delivery, identify a geographic neighborhood having orders, identify AGVs for delivery in the neighborhood, instruct the AGVs to form the first linked orientation, and instruct navigation of the AGV chain to an initial detachment location in the neighborhood. The AGVs detach in the neighborhood, complete their individual deliveries, and navigate to a predetermined relinking location in the neighborhood.

### CROSS-REFERENCE TO RELATED APPLICATION

This application claims the benefit of U.S. Provisional Application No. 62/637,568, filed Mar. 2, 2018, which is incorporated by reference in its entirety herein.

### TECHNICAL FIELD

This invention relates generally to autonomous ground vehicles, and more particularly, to autonomous ground vehicles (AGVs) used to deliver merchandise.

### BACKGROUND

In the retail setting, autonomous ground vehicles are being used with ever increasing frequency. These autonomous ground vehicles may move about and operate in an independent or semi-independent manner without the need for a human operator in many circumstances. Some of the uses for autonomous ground vehicles may include, for example, transporting merchandise to a customer or other destination.

In this context, it is becoming important to try to employ autonomous ground vehicles to make merchandise deliveries in a safe and efficient manner. The use of autonomous ground vehicles may be desirable to make deliveries to multiple customers in a neighborhood during the same general time period. It would be desirable to develop approaches that improve the visibility, safety, and/or fuel efficiency of autonomous ground vehicles making such deliveries.

### BRIEF DESCRIPTION OF THE DRAWINGS

Disclosed herein are embodiments of systems, apparatuses and methods pertaining to the transport and delivery of merchandise using a plurality of autonomous ground vehicles. This description includes drawings, wherein:

FIG. 1 is a schematic diagram in accordance with some embodiments;

FIG. 2 is a block diagram in accordance with some embodiments;

FIG. 3 is a schematic diagram in accordance with some embodiments;

FIG. 4 is a schematic diagram in accordance with some embodiments;

FIGS. 5A and 5B are schematic diagrams in accordance with some embodiments;

FIG. 6 is a block diagram in accordance with some embodiments;

FIG. 7 is a flow diagram in accordance with some embodiments;

FIG. 8 is a block diagram in accordance with some embodiments; and

FIG. 9 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for delivering merchandise using autonomous ground vehicles linking to and unlinking from other autonomous ground vehicles. In some embodiments, there is provided a system including: a plurality of autonomous ground vehicles for transporting merchandise items, each autonomous ground vehicle (AGV) comprising: a motorized locomotion system configured to facilitate movement of the AGV; a navigational system configured to guide movement of the AGV and avoid obstacles; a storage area configured to hold a merchandise item; a vehicle body having a first end and a second end; a first coupler at the first end of the vehicle body and configured for linking to a coupler of another AGV; a second coupler at the second end of the vehicle body and configured for linking to a coupler of another AGV; at least one proximity sensor configured to detect linking of the first coupler or the second coupler to the coupler of another AGV; a transceiver configured for wireless communication; and an AGV control circuit operatively coupled to the motorized locomotion system, the at least one proximity sensor, and the transceiver, the AGV control circuit configured to operate and move the AGV. The system further includes a first linked orientation in which the plurality of AGVs are linked end to end to one another by the couplers in a predetermined sequential order to form an AGV chain; and a plurality of delivery routes, each delivery route corresponding to an AGV and including a delivery location for each AGV. The system also includes a centralized control circuit configured to: receive a plurality of merchandise orders for delivery; identify a geographic neighborhood having at least a predetermined number of the plurality of merchandise orders for delivery; identify a plurality of AGVs and assign each AGV to delivery of each merchandise order in the geographic neighborhood; instruct the plurality of AGVs to form the first linked orientation in the predetermined sequential order; and instruct navigation of the AGV chain from a starting location along a common delivery route to an initial detachment location in the geographic neighborhood, the plurality of AGVs traveling along the common delivery route in the first linked orientation to the initial detachment location. In the system, an AGV at the end of the AGV chain is configured to detach from the other AGVs upon arriving at the initial detachment location and to navigate to its corresponding delivery location to deliver its merchandise item; the other AGVs in the AGV chain are configured to detach in the geographic neighborhood and to navigate to their corresponding delivery locations to deliver their corresponding merchandise items; and the AGVs are configured to navigate to a predetermined relinking location in the geographic neighborhood to form a second linked orientation.

In the system, in some implementations, the predetermined sequential order of the plurality of AGVs is determined by the order of detachment of the plurality of AGVs in the geographic neighborhood with the end AGV detaching from the AGV chain first. In some implementations, the centralized control circuit is physically located at a remote server at a remote command and control center or is physically incorporated into a dedicated master AGV of the plurality of AGVs, the dedicated master AGV configured with sufficient processing capability to navigate the AGV chain along the common delivery route. In some implementations, the AGV at the front of the chain is configured to navigate the AGV chain along the common delivery route to the initial detachment location. In some implementations, the navigation system comprises a global positioning system (GPS) device and wherein each AGV is configured to detach from an adjacent AGV when the GPS device detects that its real time position is within a predetermined threshold distance from its predetermined detachment location. In some implementations, the detachment of the AGVs is determined by at least one of: the shortest time required for delivery of the merchandise items, the time required to deliver the merchandise items on schedule, the shortest overall distance of travel to the delivery locations, the perishable nature of the merchandise items being delivered, the risk to the AGVs, and the probability the AGVs will succeed with their delivery missions. In some implementations, the centralized control circuit is configured to: receive real time information regarding traffic and route conditions along the common delivery route; and adjust the common delivery route based on the real time information. In some implementations, each AGV is configured, upon arrival at its delivery location, to remove a merchandise item from its storage area or to wait for removal of the merchandise item from its storage area. In some implementations, each AGV is configured to wait at the predetermined relinking location in the geographic neighborhood until a predetermined time or for a predetermined time interval to allow one or more of the other of the plurality of AGVs to complete their deliveries and to navigate to the predetermined relinking location. In some implementations, the AGVs present at the predetermined relinking location at the predetermined time or when the predetermined time interval elapses are configured to relink to form the second linked orientation. In some implementations, any of the plurality of AGVs not arriving at the predetermined relinking location at the predetermined time or when the predetermined time interval elapses is configured to individually navigate to a predetermined location. In some implementations, any of the plurality of AGVs, not arriving at the predetermined relinking location at the predetermined time or when the predetermined time interval elapses and without sufficient power to navigate to the predetermined location, is configured to transmit its real time location to the centralized control circuit and to remain at its real time location awaiting pick up.

In another form, there is provided a method of delivering merchandise using autonomous ground vehicles linking to and unlinking from other autonomous ground vehicles, the method includes: providing a plurality of autonomous ground vehicles for transporting merchandise items, each autonomous ground vehicle (AGV) comprising: a motorized locomotion system configured to facilitate movement of the AGV; a navigational system configured to guide movement of the AGV and avoid obstacles; a storage area configured to hold a merchandise item; a vehicle body having a first end and a second end; a first coupler at the first end of the vehicle body and configured for linking to a coupler of another AGV; a second coupler at the second end of the vehicle body and configured for linking to a coupler of another AGV; at least one proximity sensor configured to detect linking of the first coupler or the second coupler to the coupler of another AGV; a transceiver configured for wireless communication; and an AGV control circuit operatively coupled to the motorized locomotion system, the at least one proximity sensor, and the transceiver, the AGV control circuit configured to operate and move the AGV. The method further includes forming a first linked orientation in which the plurality of AGVs link end to end to one another by the couplers in a predetermined sequential order to form an AGV chain; and determining a plurality of delivery routes, each delivery route corresponding to an AGV and including a delivery location for each AGV. The method also includes, by a centralized control circuit: receiving a plurality of merchandise orders for delivery; identifying a geographic neighborhood having at least a predetermined number of the plurality of merchandise orders for delivery; identifying a plurality of AGVs and assigning each AGV to delivery of each merchandise order in the geographic neighborhood; instructing the plurality of AGVs to form the first linked orientation in the predetermined sequential order; and instructing navigation of the AGV chain from a starting location along a common delivery route to an initial detachment location in the geographic neighborhood, the plurality of AGVs traveling along the common delivery route in the first linked orientation to the initial detachment location. In addition, the method includes: by an AGV at the end of the AGV chain, detaching from the other AGVs upon arriving at the initial detachment location and navigating to its corresponding delivery location to deliver its merchandise item; by the other AGVs in the AGV chain, detaching in the geographic neighborhood and navigating to their corresponding delivery locations to deliver their corresponding merchandise items; and by one or more of the plurality of the AGVS, navigating to a predetermined relinking location in the geographic neighborhood to form a second linked orientation.

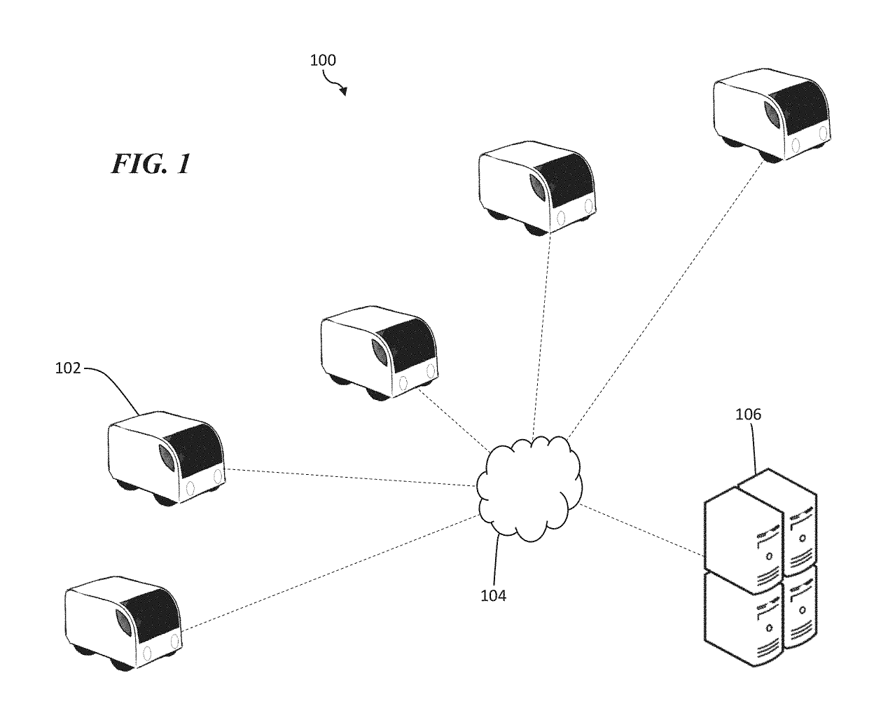

Referring to FIG. 1, there is shown a system 100 in which multiple AGVs 102 move about and operate autonomously. It is generally contemplated that the system 100 is one for the delivery of merchandise in which multiple AGVs 102 make deliveries to locations in a geographic neighborhood. During navigation to, from, and/or about the geographic neighborhood, it is contemplated that the AGVs 102 may be linked to form a chain of AGVs 102 while traveling a common portion of the delivery routes. In the system 100, to facilitate the performance of their deliveries, the AGVs 102 may communicate over a network 104. The system 100 may include a central computer system 106 accessible by one or more of the AGVs 102 over the network 104.

AGVs 102 used for delivering merchandise must deal with competing concerns when operating on roads or other routes. If the AGVs 102 are large enough to be seen easily in traffic, they may be too large to optimally carry the product loads likely to be ordered by customers. If AGVs 102 are optimized for typical customer orders, however, the AGVs 102 are likely to be too small to be seen easily in traffic. In one aspect, this disclosure is directed to the arrangement of AGV convoys that stay together as a tight group for all or part of their journey. Combined, the AGV convoy is easier for people to see and easier to account for when navigating than many AGV units traveling apart from one another. By travelling together for certain legs of their delivery journey, the AGVs 102 may maximize their visibility on the move while minimizing their overall footprint on road and other travel paths. Traveling in an AGV convoy may also improve the overall fuel efficiency relative to having the AGV units travel separately.

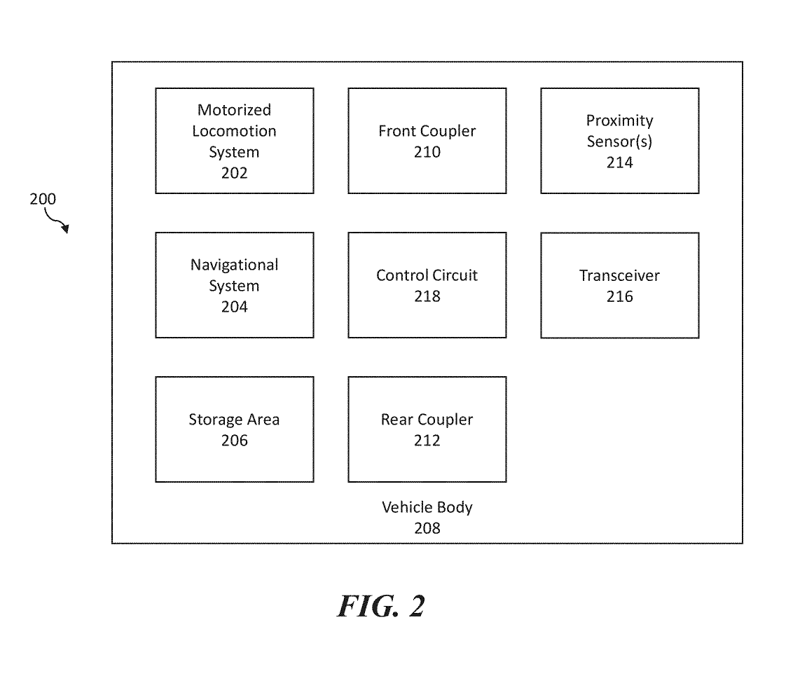

Referring now to FIG. 2, an AGV 200 (corresponding to AGV 102) for use in transporting/conveying merchandise items and for linking and unlinking with other AGVs 200 is shown. It is generally contemplated that the AGV 200 includes certain components that allow it to convey merchandise and to couple and uncouple from other AGVs 200. The AGV 200 includes a motorized locomotion system 202, a navigational system 204, a storage area 206, a vehicle body 208 with a front coupler 210 and a rear coupler 212, proximity sensor(s) 214, a transceiver 216, and a control circuit 218. It is generally contemplated that the AGVs 200 are generally interchangeable with one another, but it is also contemplated that some of the AGVs 200 may have different characteristics that make their use especially appropriate in certain circumstances.

The AGV 200 includes a motorized locomotion system 202 configured to facilitate movement of the AGV 200. It is generally contemplated that the motorized locomotion system 202 may include wheels (or tracks or legs), a motor, and a drive mechanism. For example, in one preferred form, the motorized locomotion system 202 of each AGV 200 includes two sets of wheels. The AGVs 200 also each include a power source (such as a battery or solar cell) disposed in the vehicle body 208 and configured to energize movement and operation of the AGV 200, i.e., to energize the AGV's motorized locomotion system 202 and other components. The motorized locomotion system 202 may comprise one or more motors that control one or more of a speed, direction, and/or orientation of one or more wheels (or tracks or legs) on the AGV 200. The motorized locomotion system 202 may be configured to be controlled by the control circuit 218 to move the AGV 200 in designated directions.

The AGV 200 includes a navigational system 204 for guiding movement of the AGV 200. The navigational system 204 includes sensor(s) for navigation and optionally for detecting obstacles in the AGV's path as it travels along its route. These sensor(s) may be of any of various types, including GPS, compasses and other navigational aids, gyroscopes, magnetometers, accelerometers, radar laser range finders, ultrasound range finders, infrared sensors, and optical/imaging sensors (such as video/camera devices). It is also generally contemplated that the optical/imaging sensors may permit a human operator to remotely guide the AGV 200 in certain circumstances. As part of and in addition to the navigational sensors, the AGV 200 may also include sensor(s) for determining the AGV's position relative to other objects. These sensor(s) aid in the avoidance of objects as the AGV 200 travel to, from, and/or about a geographic neighborhood.

The AGV 200 includes a merchandise storage area 206, such as a storage compartment, that may be suited to carrying packages and/or other types of cargo. As should be evident, the storage area 206 may be any of various physical sizes and geometries. In one form, it is generally contemplated that the merchandise storage area 206 may be a storage compartment formed in the interior of the vehicle body 208 that may be removably covered by a lid of the compartment. It is generally contemplated that the AGV 200 with a storage area 206 is used to transport merchandise to customers in a geographic neighborhood.

The AGV 200 further includes a vehicle body 208 having a first end and a second end, i.e., generally front and back ends. In one form, it is generally contemplated that the AGVs 200 link to one another to form a chain by coupling to one another end to end, i.e., the front of one AGV 200 couples to the back of a second AGV 200, the front of the second AGV 200 couples to the back of a third AGV 200, etc. In order to accomplish this linking, each AGV 200 includes a first coupler 210 at one end of the vehicle body 208 for linking to a coupler of a second AGV 200 and also includes a second coupler 212 at the other end of the vehicle body 208 for linking to a coupler of a third AGV 200.

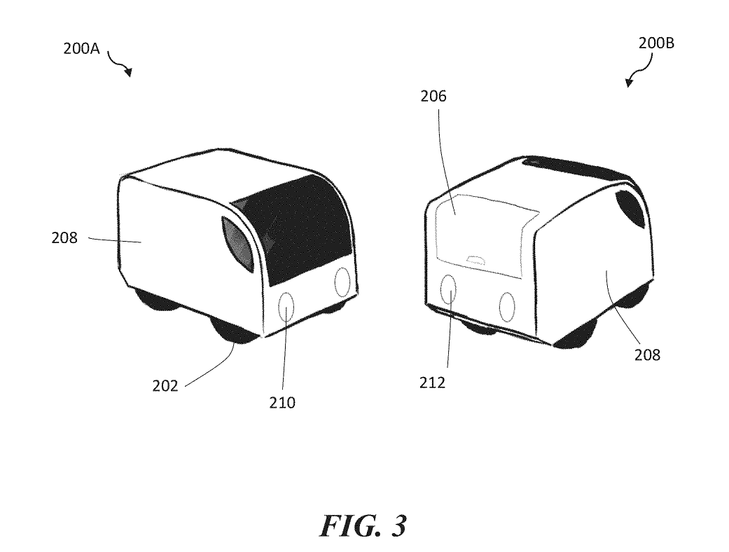

FIG. 3 shows one example of AGVs 200 with front and back couplers 210, 212 for linking to other AGVs 200. In one form, it is contemplated that the couplers 210, 212 may be in the form of magnetic connectors for coupling AGV A (200A) to AGV B (200B) (such as, for example, electromagnetic connectors or multi-pole magnetic connectors). In this form, these magnetic connectors are generally capable of selective activation and deactivation by the control circuit 218 of each AGV 200 in order to create a chain of AGVs 200 and to separate from the chain of AGVs 200 during the delivery process. In one form, the control circuit 218 may be able to adjust the polarity of the magnetic connectors or to rotate the magnetic connectors to selectively link or unlink the front of AGV A (200A) to the back of AGV B (200B).

In this particular form, the front and rear couplers 210, 212 each include two magnetic connectors. In other words, the front coupler 210 includes two magnetic connectors that are intended to link to and unlink from two corresponding magnetic connectors of the rear coupler 212. It is generally contemplated that the AGVs 200 are modular and interchangeable such that the front and rear couplers 210, 212 each include two magnetic connectors. As should be evident, the number of magnetic connectors on the front and rear ends need not be two and may be reduced or increased, as desired. Some examples of types of magnetic connectors include, without limitation, electromagnetic and multi-pole magnetic connectors.

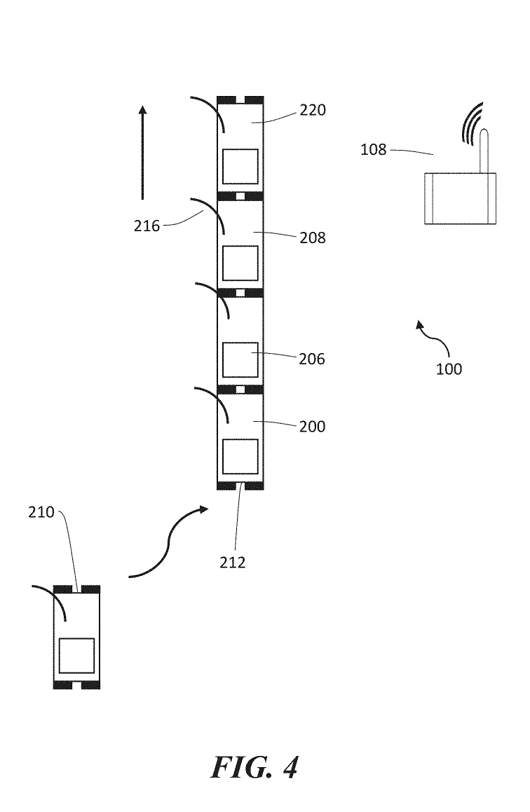

FIG. 4 shows one example of AGVs 200 linking to one another to form an AGV chain. In one form, it is contemplated that the system 100 may include a command and control center 108 that communicates with the AGVs 102/200. Each AGV 200 includes a transceiver 216 with which it may wirelessly communicate with the command and control center 108 and possibly with other AGVs 200. The transceiver 216 may, for example, comprise one or more of a WLAN transceiver, a WWAN transceiver, a mobile data network transceiver, a satellite network transceiver, a WiMax transceiver, a Wi-Fi transceiver, a Bluetooth transceiver, and the like. In one form, as addressed further below, it is contemplated that the command and control center 108 may provide, at least, some of the navigational inputs and information to the AGVs 200 to guide the AGVs 200 to their individual delivery locations. However, in another form, it is contemplated that the system 100 may have a “smart” AGV 220 (or “mothership”) that navigates and makes many of the decisions for the chain of AGVs 200, such as navigating the AGVs 200 when they are linked to one another.

In the system 100, it is generally contemplated that the AGVs 200 may selectively unlink from one another during travel to their individual delivery locations. As can be seen in FIG. 4, four AGVs 200 are linked to one another to form a chain, and in this example, a fifth, unlinked AGV 200 moves to link to the fourth, end AGV 200. As addressed above, each AGV 200 includes a front coupler 210 on the front end of the vehicle body 208 and a rear coupler 212 on the back end of the vehicle body 208. When linking, the unlinked AGV 200 may approach the end AGV 200 and position itself in close proximity to the end AGV 200, and the end AGV 200 and unlinked AGV 200 may then activate their couplers 210, 212 to attract and link the unlinked AGV 200 to the end of the chain. When unlinking, the fifth AGV 200 may selectively deactivate its front coupler 210 to decouple from the chain of AGVs 200, such as when it is approaching its individual delivery destination and is decoupling to complete the delivery.

In the system 100, the AGVs 200 are linked in the chain in a certain sequential order. In other words, the system 100 includes a first linked orientation in which the AGVs 200 are linked end to end to one another by couplers 210, 212 in a predetermined sequential order to form the AGV chain. For example, in FIG. 4, the last AGV 200 in the chain (the fifth AGV) is intended to be the first to unlink once the AGV chain arrives in the geographic neighborhood, so it is located at the back end of the chain. Further, the penultimate AGV 200 in the chain (the fourth AGV) is intended to be the second to unlink in the geographic neighborhood, so it will unlink after the last AGV (the fifth AGV) has already unlinked. In this example, the unlinking continues in this sequence until all of the AGVs 200 have unlinked from one another, and the original sequential arrangement of the AGVs 200 chain facilitates this unlinking order. In other words, the sequential order of the AGV chain may be determined by the order of detachment from the chain. In this example, the predetermined sequential order of the AGVs 200 is determined by the order of detachment of the plurality of AGVs 200 in the geographic neighborhood with the end AGV detaching from the AGV chain first.

In the system 100, it is generally contemplated that the AGVs 200 will travel in a group to and from the geographic neighborhood in order to improve fuel efficiency, visibility, and safety. In other words, the AGVs 200 will travel in a convoy along a common route to and from the geographic neighborhood. However, the AGVs 200 will unlink in the neighborhood to travel a unique delivery path to their individual customer locations. In other words, the system 100 includes a plurality of delivery routes with each delivery route corresponding to an AGV 200 and including a delivery location for each AGV 200.

The AGV 200 also includes proximity sensor(s) 214 configured to detect linking of the front coupler 210 and/or the rear coupler 212 to the coupler of another AGV 200. It is generally contemplated that the proximity sensor(s) 214 indicate and confirm to the AGV control circuit 218 that the particular AGV 200 is coupled to another AGV 200. These proximity sensor(s) 214 can therefore be used collectively to determine when all of the desired AGVs 200 are coupled to one another to define the desired chain length. Any of various types of proximity sensor(s) 214 may be used, such as without limitation photoelectric, infrared, inductive, capacitive, and ultrasonic sensors, and the like. Proximity sensor(s) 214 may also include contact or touch sensors.

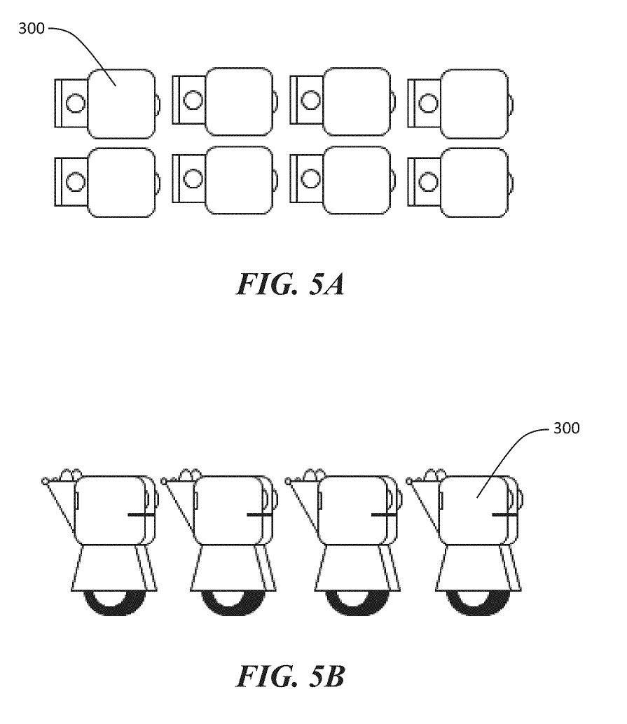

Although FIG. 4 shows the front and rear couplers 210, 212 coming into physical contact with one another for coupling (such as via magnetic connectors), it is also contemplated that the coupling need not require physical contact. For example, FIGS. 5A and 5B show another form of AGV 300 in which the AGVs 300 may travel in a logic train in which they travel together in close proximity to one another but without touching one another. It is generally contemplated that AGV 300 may include many of the same components of AGV 200 (such as a motorized locomotion system 202, a navigational system 204, a storage area 206, a vehicle body 208, proximity sensor(s) 214, a transceiver 216, and a control circuit 218), but not necessarily a front coupler 210 and a rear coupler 212 (although couplers may still serve a useful purpose, such as towing of a disabled AGV 300). In this form, it is contemplated that each AGV 300 includes sensor(s) that allow it to maintain this close proximity to other AGVs 300 during travel without colliding with other AGVs 300. Further, all of the AGV units may cooperate and act as one vehicle by a distributive network or by communicating with a central server/central computer system 106 (that may generally provide simultaneous commands to the AGV units). In one form, the central server/central computer system 106 may treat all of the AGVs 300 as one single entity such that their actions are collectively coordinated.

In addition, the AGVs 200, 300 include a control circuit 218 operatively coupled to, at least, the motorized locomotion system 202, the proximity sensor(s) 214, and transceiver 216 (and optionally to the navigational system 204, storage area 206, and/or front and rear couplers 210, 212). The control circuit 218 is configured to operate and move the AGV 200. The control circuit 218 may comprise a processor, a microprocessor, and the like and may be configured to execute computer readable instructions stored on a computer readable storage memory. The computer readable storage memory may comprise volatile and/or non-volatile memory and have stored upon it a set of computer readable instructions which, when executed by the control circuit 218, cause the control circuit 218 to move and operate the AGV 200 and communicate with other devices. The architectural options for such structures are well known and understood in the art and require no further description here. The control circuit 218 is configured (for example, by using corresponding programming as will be well understood by those skilled in the art) to carry out one or more of the steps, actions, and/or functions described herein.

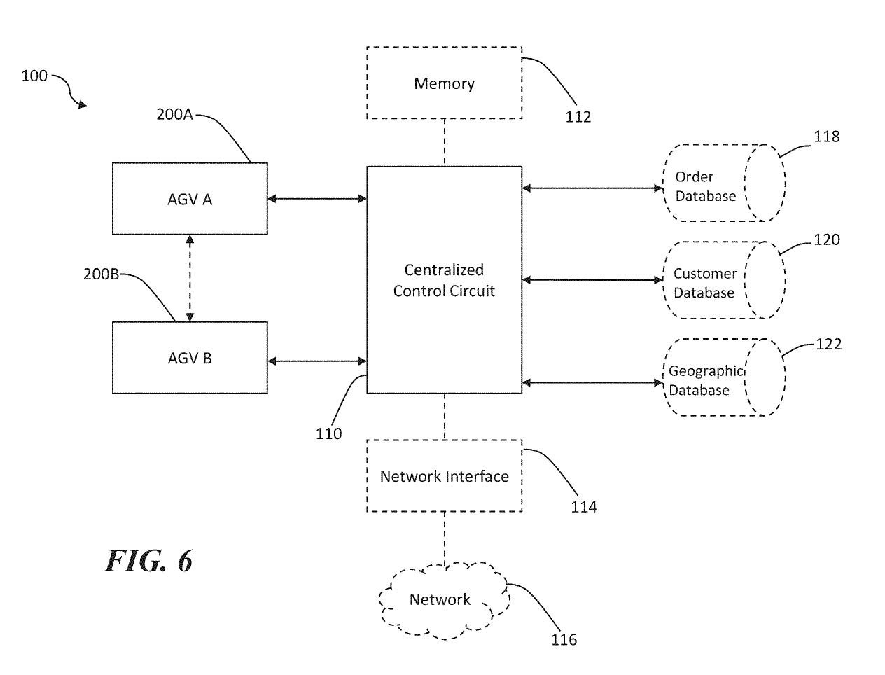

Referring now to FIG. 6, there is shown the role and operation of a centralized control circuit 110 in the system 100. In one preferred form, it is generally contemplated that the centralized control circuit 110 is physically located at a remote server at a remote command and control center 108 (from the AGVs 200 and the geographic neighborhood). Alternatively, it is contemplated that the centralized control circuit 110 may be physically incorporated into a specialized AGV control circuit 218 having additional processing and/or storage capacity relative to the standard AGV control circuits 218. In other words, in an alternative form, the centralized control circuit 110 may be physically incorporated into a dedicated master AGV 200, and further, this dedicated master AGV 200 may be configured with sufficient processing capability to navigate the AGV chain along the common delivery route.

In FIG. 6, there are shown two AGVs (AGV A (200A) and AGV B (200B)) that may communicate with one another, but as should be evident, it is contemplated that additional AGVs 200 may be used in the system 100 (that may also communicate with one another). Each AGV 200 is communicatively coupled to the centralized control circuit 110. Further, as addressed below, the centralized control circuit 110 is also communicatively coupled to one or more databases that may include data relating to the merchandise orders being delivered, the customers, the geographic neighborhood, etc.

As described herein, the language “centralized control circuit” refers broadly to a system including any microcontroller, computer, or processor-based devices with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The centralized control circuit 110 may be configured (for example, by using corresponding programming stored in a memory as will be well understood by those skilled in the art) to carry out one or more of the steps, actions, and/or functions described herein.

As shown in FIG. 6, the centralized control circuit 110 may be coupled to a memory 112, a network interface 114, and network(s) 116. The memory 112 can, for example, store non-transitorily computer instructions that cause the centralized control circuit 110 to operate as described herein, when the instructions are executed, as is well known in the art. Further, the network interface 114 may enable the centralized control circuit 110 to communicate with other elements (both internal and external to the system 100). This network interface 114 is well understood in the art. The network interface 114 can communicatively couple the centralized control circuit 110 to whatever network or networks 116 may be appropriate for the circumstances. In this form, it is contemplated that the centralized control circuit 110 may access one or more databases (including, for example, order database 118, customer database 120, and/or geographic database 122) to collect data for performing its functions.

The centralized control circuit 110 is configured to receive a plurality of merchandise orders for delivery. For example, the centralized control circuit 110 may be communicatively coupled to an order database 118 to access merchandise order(s). In one form, customers may place merchandise orders with a retailer in any of various ways, such as by calling in an order or by transmitting the order online by smartphone or other computing device. The individual merchandise orders may be stored in the order database 118.

The centralized control circuit 110 is further configured to identify a geographic neighborhood having at least a certain number of the merchandise orders for delivery. It is generally contemplated that the AGV chain will make deliveries that are sufficiently proximate to one another that the AGVs 200 can travel to the general delivery area in a group, can then separate to complete individual deliveries, and can then re-group at a designated location. The geographic neighborhood may be determined in various ways. For instance, the geographic neighborhood may be defined on a city by city basis, by zip code, or by customers located within a predetermined maximum radial distance from a central location. In one form, this determination may be facilitated by accessing the order database 118 or by accessing a customer database 120 that may include relevant customer information, such as the addresses of the delivery locations.

The centralized control circuit 110 is also configured to identify AGVs 200 and assign each AGV 200 to delivery of each merchandise order in the geographic neighborhood. In one simple form, these AGVs 200 may be readily available, such as at a store or at a merchandise distribution center, and this identification may involve selecting a number of available AGVs 200 corresponding to the number of delivery orders. In another form, the identification and assignment of AGVs 200 may also involve checking certain conditions of each AGV 200, such as power levels, merchandise storage capacity, etc., in order to determine that a selected AGV 200 can handle a specific merchandise order. The assignment of each AGV 200 may also involve transmitting navigational information to the AGV 200, such as the GPS coordinates of the delivery location of the particular order assigned to that AGV 200.

The centralized control circuit 110 is configured to instruct the AGVs 200 to form the first linked orientation in the predetermined sequential order. It is generally contemplated that the centralized control circuit 110 may determine one or more separation points for the AGVs 200 to separate from the AGV chain. In a simple form, the AGVs 200 may all separate from one another at one separation point in the geographic neighborhood, but even in this circumstance, the AGVs 200 may decouple in a certain order with the end AGV 200 decoupling first, the penultimate AGV 200 decoupling second, etc. In another form, the AGVs 200 will separate one at a time as the AGV chain arrives at multiple different separation points. For example, each AGV 200 may decouple or delink when it is within a certain distance from its intended delivery location. This order of decoupling in the geographic neighborhood determines the order in which the AGV chain should be arranged.

The centralized control circuit 110 is further configured to instruct navigation of the AGV chain from a starting location along a common delivery route to an initial detachment location in the geographic neighborhood with the AGVs 200 traveling along the common delivery route in the first linked orientation to the initial detachment location. In one form, the starting location may be at a store or merchandise distribution center (or elsewhere), but in other forms, it is contemplated that a large delivery vehicle may transport and then drop off or release the AGVs 200 near the geographic neighborhood. In one form, the centralized control circuit 110 may calculate the common delivery route itself and then instruct navigation along this calculated route. However, in another form, it is contemplated that the centralized control circuit 110 may simply transmit the initial detachment location to the lead/head AGV unit (or to all of the AGVs 200) and then the lead AGV unit may calculate the common delivery route to the initial detachment location. In other words, the head AGV 200 may handle navigation of the AGV chain to the neighborhood along the common delivery route to the initial detachment location.

It is contemplated that the common delivery route to the neighborhood may be adjusted based on real time traffic and route information. In one form, the centralized control circuit 110 may be configured to: receive real time information regarding traffic and route conditions along the common delivery route; and adjust the common delivery route based on the real time information. Alternatively, it is contemplated that this real time adjustment may be handled by a head/lead AGV unit, rather than from a remote command and control center 108. The real time traffic and route information may include, without limitation, such things as traffic congestion, traffic accidents, poor road or route conditions, road closures, local events, obstacles, last minute changes in delivery locations, etc.

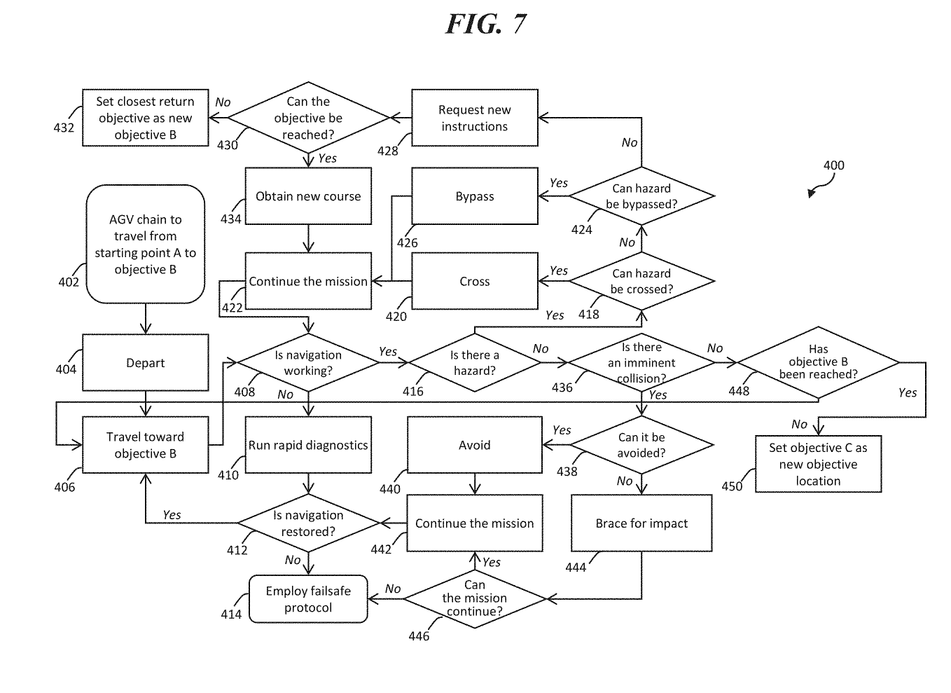

Referring to FIG. 7, there is shown a flow chart with one example of a decision making process 400 during navigation of the AGV chain. At block 402, the AGV convoy/chain has been assigned to travel from a starting point A to an objective location B (initial detachment location). At blocks 404 and 406, the AGV chain departs and travels toward the objective location B.

At blocks 408, 410, 412, and 414, the process 400 determines whether the navigation system is working, and it is generally contemplated that this navigation check will be performed periodically and repeatedly during the journey to the objective location B. At block 408, the process 400 asks if the navigation system is working, such as, for example, checking whether a GPS device is operational and/or providing reasonable position data. If the navigation system is not working, the process 400 proceeds to block 410 where a rapid diagnostics check is performed and corrective action may be taken. At block 412, the process 400 determines if navigation has been restored, and if so, the AGV chain continues to travel toward objective location B (block 406). If navigation has not been restored, however, the AGV chain employs a failsafe protocol (block 414). One example of a failsafe protocol is to have the AGV chain stop and wait a predetermined time and then check to see if navigation has been restored (such as the GPS device now being operational). In this example, if the predetermined time has elapsed without navigation having been restored, an individual in a large transport vehicle may be sent out to try to correct the navigation system, and if unsuccessful, to load the AGV chain onto the transport vehicle to transfer the AGV chain to a suitable facility for maintenance.

If the navigation system is functioning (block 408), the process 400 then determines the presence of a hazard (block 416) and the corresponding actions to be taken if a hazard is encountered (such as, for example, an obstacle blocking the delivery route or a busy intersection). It is generally contemplated that the hazard may be detected by the AGV sensors, such as those described earlier in this disclosure. It is generally contemplated that this hazard detection will be performed periodically and repeatedly during the journey to the objective location B.

At block 418, a hazard has been detected, and the AGV chain determines if the hazard can be crossed (such as by waiting for movement of an obstacle or a break in traffic at a busy intersection). If the hazard can be crossed, the AGV chain takes that crossing action (block 420), continues the delivery mission (block 422), and returns to conduct a check of the navigation system (block 408). At block 424, if a hazard has been detected but it cannot be crossed, then the AGV chain determines if the hazard can be bypassed. For example, if an obstacle has not moved within a certain amount of time (or there has not been a break in traffic for a certain amount of time), the AGV chain will try to bypass the hazard, such as by going around an obstacle. The AGV chain performs the bypass action (block 426), continues the delivery mission (block 422), and then conducts another check of the navigation system (block 408).

If the AGV chain cannot bypass the hazard, however, the AGV chain requests new instructions (block 428), such as from a remote command and control center 108. At block 430, a determination is made as to whether the objective (objective location B) can be reached. If not, the AGV chain may travel to a new objective location (block 432), such as, for example, returning to the original starting point A, traveling to a nearby store or distribution center, traveling to a rendezvous location (such as for pick up by a large transport vehicle), or traveling to a new geographic neighborhood for other deliveries. If the objective can be reached, however, the AGV chain obtains a new course (block 434), continues the delivery mission (block 422), and performs a check of the navigation system (block 408).

At block 436, if no hazard is detected, the AGV chain determines if a collision is imminent (such as indicated by AGV sensors). For example, the AGV chain may detect that another object is on a collision course with the AGV chain. It is generally contemplated that this collision detection will be performed periodically and repeatedly during the journey to the objective location B.

At block 438, the AGV chain determines if the collision can be avoided (such as by stopping or by changing the direction or speed of the AGV chain). If the collision can be avoided, the AGV chain takes avoidance action (block 440) and continues with the mission (block 442). Following the near collision, the AGV chain determines if the navigation system is restored/working (block 412).

If the AGV chain determines that the collision cannot be avoided, the AGV chain takes any appropriate action to brace for the impact of (or minimize the damage resulting from) the collision (block 444). For example, this action may involve stopping the AGV chain or changing the direction and speed of the AGV chain, which may not be sufficient to avoid the collision but may reduce the impact of the collision. Following the collision, a determination is made as to whether the delivery mission can continue (block 446). If yes, the AGV chain continues with the mission (block 442). If not (because the AGVs can no longer move sufficiently), the AGV chain may employ a failsafe (block 414) such as was described above.

If a collision is not imminent, the AGV chain determines whether the objective location B has been reached (block 448). If the objective location B has not been reached, the process 400 continues travel to objective B along the delivery route (block 406). As should be understood, this process 400 is an iterative one with periodic and repeated checks that the navigation system is working, whether there are upcoming hazards (and whether they can be crossed and bypassed), and whether there are imminent collisions (and whether they can be avoided). These checks continue until objective location B is reached.

At block 450, objective location B has been reached, and at this point, a new objective location C may be determined or assigned. In one form, it is contemplated that objective location B is the initial detachment location and that one or more of the individual AGVs 200 will detach, continue along individual delivery routes to their assigned delivery locations, and then rendezvous at a regrouping location where the AGVs will relink to form another chain. From this regrouping location, the AGV chain may travel to various new objective locations C, such as, for example, returning to the original starting point A, traveling to a nearby store or distribution center, traveling to a pick up location (such as for pick up by a large transport vehicle), or traveling to a new geographic neighborhood for other deliveries.

As addressed above, when the AGV chain arrives in the designated neighborhood, the AGV 200 at the end of the AGV chain is configured to detach from the other AGVs 200 upon arriving at the initial detachment location. The end AGV 200 then navigates to its corresponding delivery location to deliver its merchandise item. The other AGVs 200 in the AGV chain then also detach in the geographic neighborhood (at one or more detachment locations) and navigate to their corresponding delivery locations to deliver their corresponding merchandise items. In one form, it is contemplated that the centralized control circuit 110 initially calculates the individual delivery route of each AGV 200 and transmits this route to each AGV 200. However, in another form, the centralized control circuit 110 or head AGV unit may simply transmit GPS coordinates to each AGV 200 and allow each AGV 200 to calculate its own individual delivery route to the customer's delivery location.

In one form, the detachment of the AGVs 200 may be triggered automatically when the AGV gets within a certain threshold distance of either its assigned detachment location or its assigned delivery location. In this form, it is the AGV 200 that is currently at the end of the AGV chain that detaches when it is within the threshold distance (the other, intermediate AGVs 200 will not be permitted to detach). It is generally contemplated that the navigation system of each AGV 200 includes a GPS device and that each AGV 200 is configured to detach from an adjacent AGV 200 when the GPS device detects that its real time position is within the threshold distance from its designated detachment location (or from the customer delivery location).

The detachment of the AGVs 200 and their separation locations may be determined in several ways. As indicated above, in one simple form, all of the AGVs 200 may detach at one general location, i.e., at the initial detachment location. However, in another form, the AGVs 200 may detach at multiple different detachment/separation locations according to a desired factor. For example, detachment of the AGVs 200 may be determined by at least one of the following: the shortest time required for delivery of the merchandise items, the time required to deliver the merchandise items on schedule, the shortest overall distance of travel to the delivery locations, the perishable nature of the merchandise items being delivered, the risk to the AGVs, and the probability the AGVs will succeed with their delivery missions.

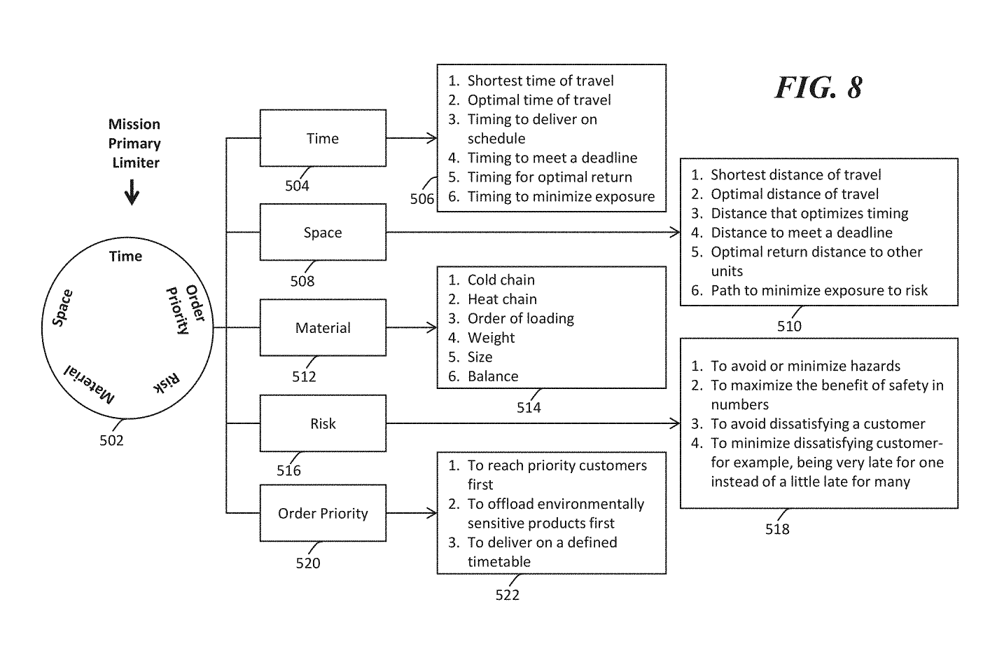

Referring to FIG. 8, various factors are shown that may be taken into account in determining the AGV detachment locations and order of detachment. In one form, prior to the departure of the AGV chain, it may be determined that one or more factors may be selected to determine the priority of the merchandise deliveries (block 502). If a merchandise order is given the highest priority, it may be connected to the end of the AGV chain so that it may delink first (and possibly complete its delivery route first). In this manner, the selection of the factor(s) given priority may determine the AGV detachment locations, order of detachment, and/or route through the neighborhood.

FIG. 8 shows examples of five overlapping factors that may be selected for prioritization and how these factors might be measured. A first factor is time (block 504), which may be measured, without limitation, based on the shortest time of travel, the optimal time of travel, timing required to deliver certain orders on schedule, timing to meet a deadline (including rush orders), timing for optimal return, and timing to minimize exposure of the AGV chain to risk (block 506). A second factor is space or distance (block 508), which may be measured, for example, based on the shortest distance of travel, the optimal distance of travel, the distance that optimizes timing, the distance to meet a deadline, the optimal return distance to other AGV units, and the path to minimize exposure to risk (i.e., busy intersections and other potential road hazards to the AGVs) (block 510). A third factor is the merchandise material (block 512), which may be measured, without limitation, based on cold chain (frozen or perishable items should be delivered first), heat chain (heated food or other merchandise should be delivered first), order of loading (an AGV loaded with merchandise first should deliver first), weight (AGVs with heavier merchandise should deliver first because of their increased rate of power consumption relative to other AGVs), size of the merchandise, and balance of the merchandise (block 514). A fourth factor is risk (block 516), which may be measured, for example, based on avoiding or minimizing hazards (for example, selecting less traveled roads with less fewer/less busy intersections), maximizing the benefit of safety in numbers (for example, the AGV chain needs to be a certain minimum number of AGV units for visibility), avoiding dissatisfying a customer (for example, one customer has a critical deadline), and minimizing dissatisfying customers (for example, being very late for one delivery instead of a little late for many deliveries) (block 518). A fifth factor is order priority (block 520), which may be measured, without limitation, based on delivering to priority customers first, offloading environmentally sensitive products first, and delivering on a defined timetable (block 522).

Following detachment, each of the AGVs 200 then proceeds to its assigned delivery location where it delivers the merchandise. The actual delivery may be handled in various ways. For example, in one form, upon arrival at the delivery location, the AGV 200 may include a robot arm or other mechanism to remove the merchandise from the merchandise storage area 206 and deposit it outside of the AGV 200. In another form, the AGV 200 may simply wait at the assigned delivery location for the customer or other individual to remove the merchandise item from the storage area 206.

Following detachment and delivery, the AGVs 200 are configured to navigate to a relinking location in the geographic neighborhood to form a second linked orientation. By relinking in the neighborhood following their individual deliveries, the AGVs 200 can again take advantage of some of the benefits of traveling in an AGV chain, including increased visibility, safety, and fuel efficiency. Following relinking, it is contemplated that AGV chain may travel to any of various destinations, such as, for example, returning to the original starting point, traveling to a nearby store or distribution center, traveling to a rendezvous location (such as for pick up by a large transport vehicle), or traveling to a new neighborhood for other deliveries.

Some of the AGVs 200 may experience difficulty or delay in reaching the relinking location and may be unable to reach the relinking location at all. In one form, each AGV 200 may be configured to wait at the relinking location in the geographic neighborhood until an appointed time (such as 5:00 pm) or for a certain time interval (such as one hour) to allow the other AGVs 200 to complete their deliveries and to navigate to the relinking location. Further, in this form, the AGVs 200 present at the relinking location at the appointed time (such as 5:00 pm) or when the predetermined time interval elapses (such as one hour) may be configured to relink to form the second linked orientation. So, under this approach, the AGVs 200 may continue on in an AGV chain without the missing or tardy AGVs 200.

Under this approach, the AGVs 200 that do not relink may navigate to a designated location separately or wait for pick-up. For instance, any of the AGVs 200 not arriving at the relinking location at the appointed time (such as 5:00 pm) or when the predetermined time interval elapses (such as within one hour) may be configured to individually navigate to another location (such as returning to its original starting location, traveling to a nearby store or distribution center, traveling to a designated rendezvous location (such as for pick up by a large transport vehicle), or traveling to a new neighborhood for other deliveries). Further, under this approach, any of the AGVs 200, not arriving at the relinking location at the appointed time (such as 5:00 pm) or when the predetermined time interval elapses (such as one hour) and without sufficient power to navigate to another designated location, may be configured to transmit its real time location to the centralized control circuit 110 and to remain at its real time location awaiting pick up.

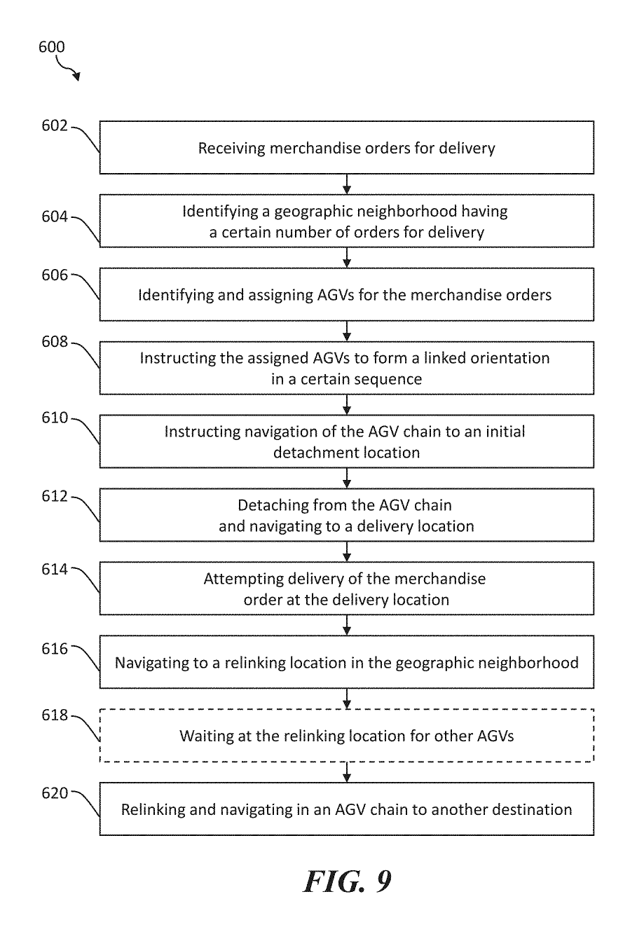

Referring to FIG. 9, there is shown a process 600 for making multiple merchandise deliveries to customers in a geographic neighborhood. The process 600 generally uses an AGV to deliver each merchandise order. The AGVs link to form an AGV chain for travel to the neighborhood, then unlink to make individual deliveries of the merchandise orders, and then relink to again form an AGV chain and proceed to another destination. The process 600 may use the AGVs 200 and 300 and other components of system 100 described above.

At block 602, merchandise orders for delivery are received. It is generally contemplated that these orders may be placed by customers over a certain time period. These orders may be called in by phone, may be transmitted by smartphone or other computing device, or may be otherwise communicated. In one form, these merchandise orders may be stored in an order database.

At block 604, a geographic neighborhood having a certain number of orders for delivery is identified. It is generally contemplated that a preferably compact neighborhood is selected in which a certain minimum number of customers have placed orders such that an AGV chain can economically travel to and make deliveries in the neighborhood. The neighborhood may be selected by any of various measures, including, for example, on a town or city basis, by zip code, by a certain maximum sized area, by population, etc.

At block 606, AGVs are identified and assigned for the merchandise orders to be delivered in the neighborhood. In one form, the AGVs are generally interchangeable, and an AGV may be identified and assigned based generally on the availability of the AGV, i.e., it is not performing another task. In another form, the AGVs may have different characteristics (such as a large merchandise storage area or a power source with the capacity for longer trips) that may make them especially suitable for a certain delivery. The AGVs may include the components of AGV 200 described above.

At block 608, the assigned AGVs are instructed to form a linked orientation in a certain sequence. In one form, it is contemplated that the AGVs will detach from the AGV chain in a certain sequence and the sequential order of the AGVs in the chain will be determined by their order of detachment in the geographic neighborhood with the end AGV detaching from the AGV chain first. In this form, if all of the AGVs detach at one detachment location in the neighborhood, it is contemplated that the end AGV will detach first, the penultimate AGV will detach second, etc.

At block 610, navigation of the AGV chain is instructed to an initial detachment location in the neighborhood. In one form, the AGV chain may be instructed to follow a specific route determined by a centralized control circuit. In another form, it is contemplated that GPS coordinates of the initial detachment location may be provided to the lead AGV, which then calculates and navigates a route to the initial detachment location. Further, it is contemplated that real time information regarding traffic and route conditions along the common delivery route may be received and that that the common delivery route may be adjusted based on this real time information.

At block 612, the AGVs detach from the AGV chain and navigate to a delivery location. It is generally contemplated that some or all of the AGVs may detach at the initial detachment location and that any remaining AGVs in the chain may then proceed to one or more other detachment locations. In one form, each AGV currently at the end of the AGV chain may detach from an adjacent AGV when its navigation system detects that its real time position is within a certain threshold distance from its appointed detachment location. Further, if there is more than one detachment location, the detachment locations may be determined based on various factors, including, without limitation, the shortest time required for delivery of the merchandise items, the time required to deliver the merchandise items on schedule, the shortest overall distance of travel to the delivery locations, the perishable nature of the merchandise items being delivered, the risk to the AGVs, and the probability the AGVs will succeed with their delivery missions.

At block 614, following detachment, each AGV attempts delivery of a merchandise order at its assigned delivery location. Each AGV navigates from its detachment point to the assigned delivery location (such as a customer residence or business). In one form, upon arriving at its delivery location, each AGV may remove the merchandise item being delivered from its storage area and deposit it at the delivery location. In another form, the AGV may wait for the customer to remove the merchandise item from the AGV's storage area. In this form, the AGV may be configured to wait a certain maximum amount of time for the customer to retrieve the merchandise before it proceeds to a relinking location. In addition, if the AGV is blocked from traveling to the delivery location, it may also abort the delivery mission and proceed to the relinking location.

At block 616, after attempting delivery, the AGVs navigate to a relinking location in the geographic neighborhood. This relinking location may be the initial detachment location (or any of the other detachment locations, if applicable) or may be another location that may be selected for ease of rendezvous of the AGVs. At block 618, the AGVs arriving at the relinking location may optionally wait at the relinking location until a certain time (such as 5:00 pm) or for a certain time interval (such as one hour) to allow other AGVs to attempt their deliveries and travel to the relinking location.

At block 620, the AGVs at the relinking location may then relink and navigate to another destination (such as returning to its original starting location, traveling to a nearby store or distribution center, traveling to a location for pick up by a large transport vehicle, or traveling to a new neighborhood for other deliveries). It is also contemplated that provision may be made for AGVs not present at the relinking location at the time of relinking. In one form, any of the AGVs not present to relink with other AGVs at the relinking location, may individually navigate to one of the above destinations. Additionally, any AGV that does not relink and without sufficient power to navigate to another destination may transmit its real time location to a centralized control circuit and remain at its location awaiting pick up.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system of delivering merchandise using autonomous ground vehicles linking to and unlinking from other autonomous ground vehicles, the system comprising:
a plurality of autonomous ground vehicles for transporting merchandise items, each autonomous ground vehicle (AGV) comprising:
a motorized locomotion system configured to facilitate movement of the AGV;
a navigational system configured to guide movement of the AGV and avoid obstacles;
a storage area configured to hold a merchandise item;
a vehicle body having a first end and a second end;
a first coupler at the first end of the vehicle body and configured for linking to a coupler of another AGV;
a second coupler at the second end of the vehicle body and configured for linking to a coupler of another AGV;
at least one proximity sensor configured to detect linking of the first coupler or the second coupler to the coupler of another AGV;
a transceiver configured for wireless communication;
an AGV control circuit operatively coupled to the motorized locomotion system, the at least one proximity sensor, and the transceiver, the AGV control circuit configured to operate and move the AGV;
a first linked orientation in which the plurality of AGVs are linked end to end to one another by the couplers in a predetermined sequential order to form an AGV chain;
a plurality of delivery routes, each delivery route corresponding to an AGV and including a delivery location for each AGV;
a centralized control circuit configured to:
receive a plurality of merchandise orders for delivery;
identify a geographic neighborhood having at least a predetermined number of the plurality of merchandise orders for delivery;
identify a plurality of AGVs and assign each AGV to delivery of each merchandise order in the geographic neighborhood;
instruct the plurality of AGVs to form the first linked orientation in the predetermined sequential order;
instruct navigation of the AGV chain from a starting location along a common delivery route to an initial detachment location in the geographic neighborhood, the plurality of AGVs traveling along the common delivery route in the first linked orientation to the initial detachment location;
wherein an AGV at the end of the AGV chain is configured to detach from the other AGVs upon arriving at the initial detachment location and to navigate to its corresponding delivery location to deliver its merchandise item;
wherein the other AGVs in the AGV chain are configured to detach in the geographic neighborhood and to navigate to their corresponding delivery locations to deliver their corresponding merchandise items;
wherein the AGVs are configured to navigate to a predetermined relinking location in the geographic neighborhood to form a second linked orientation.

2. The system of claim 1, wherein the predetermined sequential order of the plurality of AGVs is determined by the order of detachment of the plurality of AGVs in the geographic neighborhood with the end AGV detaching from the AGV chain first.

3. The system of claim 1, wherein the centralized control circuit is physically located at a remote server at a remote command and control center or is physically incorporated into a dedicated master AGV of the plurality of AGVs, the dedicated master AGV configured with sufficient processing capability to navigate the AGV chain along the common delivery route.

4. The system of claim 1, wherein the AGV at the front of the chain is configured to navigate the AGV chain along the common delivery route to the initial detachment location.

5. The system of claim 1, wherein the navigation system comprises a global positioning system (GPS) device and wherein each AGV is configured to detach from an adjacent AGV when the GPS device detects that its real time position is within a predetermined threshold distance from its predetermined detachment location.

6. The system of claim 1, wherein detachment of the AGVs is determined by at least one of: the shortest time required for delivery of the merchandise items, the time required to deliver the merchandise items on schedule, the shortest overall distance of travel to the delivery locations, the perishable nature of the merchandise items being delivered, the risk to the AGVs, and the probability the AGVs will succeed with their delivery missions.

7. The system of claim 1, wherein the centralized control circuit is configured to:
receive real time information regarding traffic and route conditions along the common delivery route; and
adjust the common delivery route based on the real time information.

8. The system of claim 1, wherein each AGV is configured, upon arrival at its delivery location, to remove a merchandise item from its storage area or to wait for removal of the merchandise item from its storage area.

9. The system of claim 1, wherein each AGV is configured to wait at the predetermined relinking location in the geographic neighborhood until a predetermined time or for a predetermined time interval to allow one or more of the other of the plurality of AGVs to complete their deliveries and to navigate to the predetermined relinking location.

10. The system of claim 9, wherein the AGVs present at the predetermined relinking location at the predetermined time or when the predetermined time interval elapses are configured to relink to form the second linked orientation.

11. The system of claim 10, wherein any of the plurality of AGVs not arriving at the predetermined relinking location at the predetermined time or when the predetermined time interval elapses is configured to individually navigate to a predetermined location.

12. The system of claim 11, wherein any of the plurality of AGVs, not arriving at the predetermined relinking location at the predetermined time or when the predetermined time interval elapses and without sufficient power to navigate to the predetermined location, is configured to transmit its real time location to the centralized control circuit and to remain at its real time location awaiting pick up.

13. A method of delivering merchandise using autonomous ground vehicles linking to and unlinking from other autonomous ground vehicles, the method comprising:
providing a plurality of autonomous ground vehicles for transporting merchandise items, each autonomous ground vehicle (AGV) comprising:
a motorized locomotion system configured to facilitate movement of the AGV;
a navigational system configured to guide movement of the AGV and avoid obstacles;
a storage area configured to hold a merchandise item;
a vehicle body having a first end and a second end;
a first coupler at the first end of the vehicle body and configured for linking to a coupler of another AGV;
a second coupler at the second end of the vehicle body and configured for linking to a coupler of another AGV;
at least one proximity sensor configured to detect linking of the first coupler or the second coupler to the coupler of another AGV;
a transceiver configured for wireless communication;
an AGV control circuit operatively coupled to the motorized locomotion system, the at least one proximity sensor, and the transceiver, the AGV control circuit configured to operate and move the AGV;
forming a first linked orientation in which the plurality of AGVs link end to end to one another by the couplers in a predetermined sequential order to form an AGV chain;
determining a plurality of delivery routes, each delivery route corresponding to an AGV and including a delivery location for each AGV;
by a centralized control circuit:
receiving a plurality of merchandise orders for delivery;
identifying a geographic neighborhood having at least a predetermined number of the plurality of merchandise orders for delivery;
identifying a plurality of AGVs and assigning each AGV to delivery of each merchandise order in the geographic neighborhood;
instructing the plurality of AGVs to form the first linked orientation in the predetermined sequential order;
instructing navigation of the AGV chain from a starting location along a common delivery route to an initial detachment location in the geographic neighborhood, the plurality of AGVs traveling along the common delivery route in the first linked orientation to the initial detachment location;
by an AGV at the end of the AGV chain, detaching from the other AGVs upon arriving at the initial detachment location and navigating to its corresponding delivery location to deliver its merchandise item;
by the other AGVs in the AGV chain, detaching in the geographic neighborhood and navigating to their corresponding delivery locations to deliver their corresponding merchandise items;
by one or more of the plurality of the AGVS, navigating to a predetermined relinking location in the geographic neighborhood to form a second linked orientation.

14. The method of claim 13, further comprising determining the predetermined sequential order of the plurality of AGVs by the order of detachment of the plurality of AGVs in the geographic neighborhood with the end AGV detaching from the AGV chain first.

15. The method of claim 13, further comprising, by the AGV at the front of the chain, navigating the AGV chain along the common delivery route to the initial detachment location.

16. The method of claim 13, further comprising, by each AGV, detaching from an adjacent AGV when its navigation system detects that its real time position is within a predetermined threshold distance from its predetermined detachment location.

17. The method of claim 13, further comprising, by the centralized control circuit:
receiving real time information regarding traffic and route conditions along the common delivery route; and
adjusting the common delivery route based on the real time information.

18. The method of claim 13, further comprising, by each AGV upon arrival at its delivery location: removing a merchandise item from its storage area or waiting for removal of the merchandise item from its storage area.

19. The method of claim 13, further comprising, by each AGV, waiting at the predetermined relinking location in the geographic neighborhood until a predetermined time or for a predetermined time interval to allow one or more of the other of the plurality of AGVs to complete their deliveries and to navigate to the predetermined relinking location.

20. The method of claim 19, further comprising, by each AGV present at the predetermined relinking location at the predetermined time or when the predetermined time interval elapses: relinking with the other AGVs present to form the second linked orientation.

21. The method of claim 20, further comprising, by any of the plurality of AGVs not arriving at the predetermined relinking location at the predetermined time or when the predetermined time interval elapses: individually navigating to a predetermined location.

22. The method of claim 21, further comprising, by any of the plurality of AGVs not arriving at the predetermined relinking location at the predetermined time or when the predetermined time interval elapses and without sufficient power to navigate to the predetermined location: transmitting its real time location to the centralized control circuit and remaining at its real time location awaiting pick up.
